(19) United States
(12) Patent Application Publication
(10) Pub. No.: US 2009/0174966 A1
(43) Pub. Date: Jul. 9, 2009

(54) Swivel Arm Actuator for Multiple Directions of Movement

(75) Inventor: Frank Przygodda, Villingen-Schwenningen (DE)

Correspondence Address: Thomson Licensing LLC, P.O. Box 5312, Two Independence Way, PRINCETON, NJ, 08543-5312, US

(73) Assignee: Thomson Licensing, Boulogne-Billancourt (FR)

(21) Appl. No.: 12/226,965

(22) PCT Filed: Apr. 19, 2007
(86) PCT No.: PCT/EP2007/053857

§ 371 Date: Nov. 3, 2008

(30) Foreign Application Priority Data
May 4, 2006 (DE) 10 2006 020 730.0

(51) Int. Cl. G11B 5/48

(52) U.S. Cl. 360/244.2; G9B/5.147

(57) ABSTRACT

The invention relates to a suspension arm actuator for a plurality of directions of motion, which comprises a suspension arm designed as a two-arm lever and supported against a support and mounted to said support such that it can be pivoted, said suspension arm supporting on one of its lever arms a component that has to be actuated or being operably connected to such a component and being provided with a magnetic drive on the other lever arm for initiating a first swivel motion about an axis extending perpendicularly to the suspension arm, with a magnetic drive being allocated to said suspension arm for initiating a motion perpendicularly to this swivel motion. The invention solves the problem of designing such a suspension arm such that the latter's design is less complicated and laborious. To achieve this, the two magnetic drives are combined in the magnetic drive which is arranged on the lever arm facing away from the component, and this single magnetic drive is formed such that it generates an inhomogeneous magnetic field which allows initiating both the first swivel motion of the component and the motion of the component perpendicularly thereto.

The invention relates to a suspension arm actuator for a plurality of directions of motion, in particular comprising an optical head for an optical scanning device in a device for recording and/or reproducing information.

An actuator arranged in an optical scanning device and comprising an optical head having a focal lens is intended for emission of a light beam (laser beam) onto an optical disk which is designed as an information carrier and for reception of the beam reflected by said optical disk. There are various known types of arrangement and motion of such an actuator in a scanning device. In a first type, the optical head is arranged on a slide which is moved in linear direction across the optical disk in a plane extending in parallel to said optical disk, said slide being focusable, and in a second type, the optical head is arranged at a free end of a suspension arm designed in the. form of a two-arm lever, wherein said suspension arm, which is pivoting about an axis, moves the optical head in the form of an arc in a plane extending in parallel to the recording surface of the optical disk and is focusable as well. In either type, the optical disk is held by a supporting device and driven to make a rotational motion. In particular, a suspension arm actuator allows achieving short times of access to various locations on the recording carrier.

EP-A-0 400 570 describes a suspension arm actuator which is mounted to a supporting plate such that it can be pivoted about an axis extending perpendicularly to said supporting plate. To initiate an arched first swivel motion of the optical head which is intended for a rough approach to the recording point on the disk, a magnetic drive is allocated to the suspension arm actuator on that side of the axis that is facing away from the optical head, said magnetic drive being formed of two bent bar magnets on either side of the suspension arm and each comprising a coil. A unit which is formed of a laser diode and a collimator lens system and is intended for generating a laser beam and directing said laser beam to the focal lens is mounted in the suspension arm itself such that it can be pivoted about the same axis, said unit being provided with a second magnetic drive for fine-adjusting the target position on the arched track of motion. The optical head itself is held on spring elements and is operably connected to a further magnetic drive to initiate a motion thereof in a direction perpendicular to this track of motion and, thus, to the optical disk. Due to the plurality of magnetic drives, this suspension arm actuator is very complicated and laborious.

The Japanese patent applications JP-A-5128580 and JP-A-2004227760 also describe suspension arm actuators. The suspension arm actuator described in the former document is also arranged such that it can be pivoted about an axis and is driven by a magnetic drive allocated to said suspension arm actuator and arranged on that side of the axis that is facing away from the optical head, in order to initiate an arched swivel motion of said head in parallel to an optical disk. To achieve this, a fine adjustment is provided by means of an electrode arrangement. A region of the suspension arm between the latter's axis and the optical head is formed by an electrostrictive converter plate and allows a vertical motion of the head in relation to the arched track of motion and, thus, to an optical disk. This suspension arm actuator is considered to be to disadvantage in that its configuration is likewise complicated and laborious and, what is more, requires high operating voltages.

The suspension arm actuator disclosed in JP-A-200422760 is also mounted in a pivoting manner and comprises a drive for said suspension arm actuator. The actuator is provided with a leaf spring arrangement which is, at one of its ends, securely connected to said actuator and, at its other free end, supports the optical head and is elastically bendable in a direction perpendicular to the optical disk by means of a further drive. This suspension arm actuator is considered to be to disadvantage in that it fails to be impact-resistant.

The invention aims at designing a suspension arm actuator for a plurality of directions of motion according to the preamble of claim 1 such that the design of said suspension arm actuator is less complicated and laborious.

This problem is solved in a suspension arm actuator according to the preamble of claim 1 by means of the characterizing elements thereof. Advantageous embodiments are presented in the subordinate claims.

The invention consists of a suspension arm actuator which is supported against a support in known manner, wherein the support forms a pivot axis for the suspension arm, said pivot axis extending perpendicularly to said suspension arm. Herein, the suspension arm supports a component that has to be actuated, for example an optical head, or it is operably connected to such a component, and it further supports a magnetic drive for initiating this first swivel motion. According to the invention, this magnetic drive is formed magnetic drive is formed such that it also initiates the suspension arm to make a motion perpendicular to the first swivel motion, this requiring a separate magnetic drive in prior art suspension arm actuators. This single magnetic drive is formed such that it generates an inhomogeneous magnetic field which allows initiating both the first swivel motion of the component in the plane of the suspension arm and a motion perpendicular to this plane. The suspension arm is, in particular, designed as a two-arm lever and the support of the suspension arm is positioned in the latter's center of gravity, wherein the component is arranged at one end of a lever arm and the magnetic drive is arranged on the lever arm facing away from the component.

This magnetic drive allows a considerably simplified configuration of a suspension arm actuator with a noticeably reduced diversity of components and is associated with an essential reduction in complexity, in particular with a minimization of cost.

The magnetic drive is to advantage in that it is formed by two coils which are attached to the suspension arm on either side of the longitudinal axis of said suspension arm, their coil axis extending perpendicularly to said suspension arm, and that it is further formed of a magnet which is allocated to the two coils. This magnet comprises pole shoes spaced apart from the coil axis, the coils being arranged between said pole shoes and said pole shoes generating the inhomogeneous magnetic field for said coils. Therein, pole faces which, through their orientation, generate a partial magnetic field with a different direction for each coil can be formed on the pole shoes, said partial magnetic fields each comprising a force component extending in the plane of the suspension arm and/or a force component extending perpendicularly thereto. Therein, the pole faces, each of which forms a partial magnetic field, can be arranged at an acute angle in relation to each other in order to create a partial magnetic field that is inhomogeneous as well. The intensity of the force components is defined by a control of the operating voltage for the particular coil, with the result that this initiates a swivel motion of the suspension arm in a predefined angular range in either direction and, in addition, a motion in a direction perpendicular to this swivel motion at high velocity.

Preferrably, the suspension arm is mounted in a gimbal suspension. The cardan joint allows both a swivel motion in the plane of the suspension arm and a motion perpendicular thereto. The suspension arm that has a rigid and torsionally stiff design becomes impact-resistant through this type of suspension or joint.

The invention will be illustrated below by means of an exemplary embodiment. In the associated drawings,

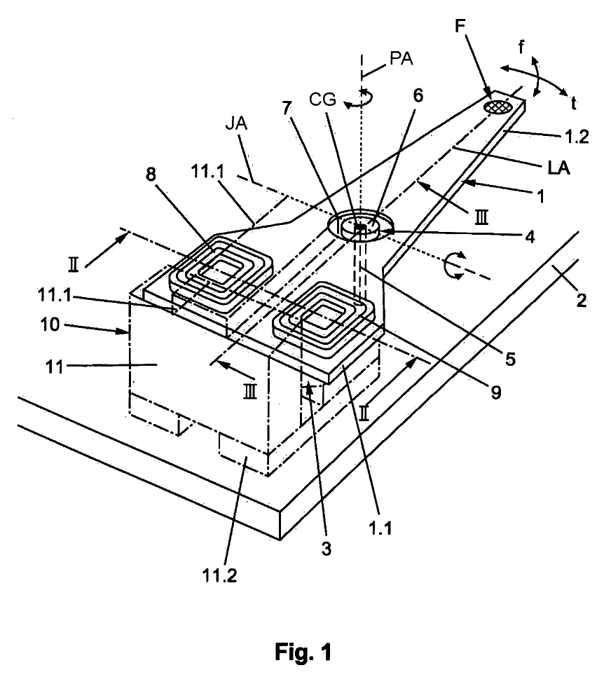

FIG. 1 is a perspective view of a suspension arm actuator with an indicated magnet arrangement;

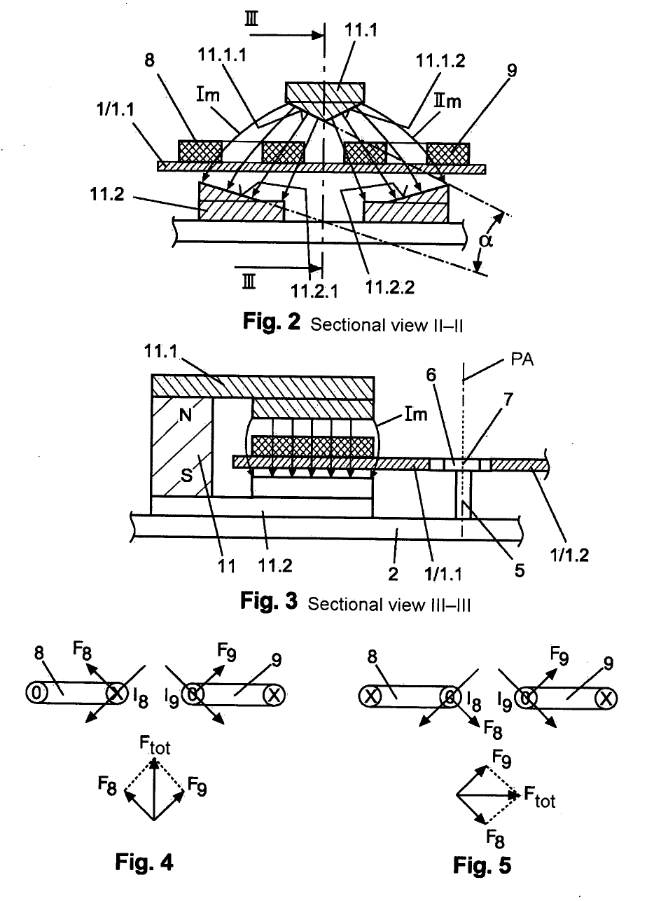

FIG. 2 is a cross-sectional view of the magnetic drive of the actuator;

FIG. 3 is a longitudinal cross-sectional view of the magnetic drive along the longitudinal axis of the suspension arm;

FIG. 4 shows a first control example for the suspension arm in relation to the rate of the current flowing through the coils; and

FIG. 5 shows a second control example.

According to FIG. 1, the suspension arm actuator for an optical scanning device (not illustrated) comprises a rigid and torsionally stiff suspension arm 1 which, in its center of gravity CG, is mounted to a support 2 in the form of a two-arm lever such that it can be pivoted as in a gimbal suspension, said suspension arm actuator further comprising a magnetic drive 3 operably connected to said suspension arm 1. The pivot bearing 4 is formed on a pivot pin 5 and spaced apart from the support 2, said pivot pin 5 being permanently arranged on and projecting vertically from said support 2, wherein said pivot bearing 4 comprises a bearing disk 6 pivoted to the pivot pin 5 and two journal bearings 7 arranged at said bearing disk 6 in transverse direction in relation to the longitudinal axis LA of the suspension arm 1 which is held by said journal bearings 7 such that it can be pivoted. On the one hand, pivoting is provided about the axis PA of the pivot pin 5 in a plane extending in parallel to the support 2 and, on the other hand, about an axis JA formed by the journal bearings 7 perpendicular in relation to said plane.

On one of the sides of the pivot bearing 4, the suspension arm 1 is provided with two coils 8 and 9 which are intended for the magnetic drive 3 and are arranged on a widened lever arm 1.1 in symmetry with respect to the longitudinal axis LA, the suspension arm 1 and the coils 8, 9 being allocated to a magnet arrangement 10 while, on the other side of the pivot bearing 4, the suspension arm 1 is provided with an optical head having a focal optical head having a focal lens F on a lever arm 1.2 that is narrower in design. The coils 8, 9 are arranged such that their coil axes extend perpendicularly in relation to the plane of the suspension arm. The magnet arrangement 10 is formed of a permanent magnet 11 which is spaced apart from the front face of the lever arm 1.1 and supports pole shoes 11.1 and 11.2 which overlap with play, on either side and in the direction of the pivot bearing 4, at least that part of the lever arm 1.1 that is provided with the coils 8, 9.

FIGS. 2 and 3 are schematic diagrams of the magnetic drive 3 with the suspension arm 1, in a sectional view taken from lines II-II in transverse direction in relation to the longitudinal axis LA thereof and in a longitudinal sectional view taken from lines III-III along the longitudinal axis LA respectively. This sectional view particularly allows distinguishing the arrangement and formation of the pole shoes 11.1 and 11.2. The latter are spaced apart from each other in relation to the axis of the coils and with play in relation to the suspension arm 1 (lever arm 1.1) which is provided with the coils 8, 9 wherein, on the side of the north pole of the permanent magnet 11, only one pole shoe 11.1 is arranged centrally above the coils 8, 9, said pole shoe 11.1 comprising two pole faces 11.1.1 and 11.1.2 formed at an angle to each other, and two pole shoes 11.2 each comprising a pole face 11.2.1 and 11.2.2 are arranged on the side of the south pole, each of said pole faces 11.2.1 and 11.2.2 being allocated to one of the pole faces 11.1.1 and 11.1.2 and each forming therewith an angle a which is acute towards the outside of the lever arm 1.1.

Therein, the pole shoes 11.2 are arranged such that an inhomogeneous partial magnetic field Iₘ and IIₘ, which penetrates the particular coil 8, 9 at a predefined angle, is formed between each of said pole shoes 11.2 and the pole shoe 11.1. Therein, the two inhomogeneous partial magnetic fields Iₘ and IIₘ have different orientations and can each generate one force component in the plane of the suspension arm 1 and one force component perpendicularly thereto. In this arrangement, the inner regions of the two coils 8, 9 that are facing each other are positioned in the stronger part of the particular partial magnetic field Iₘ, IIₘ while the outer regions that are facing away from each other are positioned in the weaker part. A swivel motion of the suspension 1 is now caused by the Lorentz forces F8 and F9 which are generated as a result of a current 18 and 19 flowing through the respective coils 8 and 9.

In the example shown in FIG. 4, the particular currents I₈ and I₉ flow through the two coils 8 and 9 respectively in the same direction, with the result that these currents flow in opposed directions in the coil regions facing each other. As a result of the inhomogeneous total magnetic field that is formed of the two partial magnetic fields Iₘ and IIₘ, the Lorentz forces F8 and F9 are directed upwards and outwards such that they diverge from each other on the side of the north pole. They result in the total force Fₜₒₜ which, on the side of the coils, swivels the lever arm 1.1 upwards about the pivot bearing 4 and perpendicularly to the support 2 and, thus, downwards (arrow f) on the side of the focal lens.

In the example shown in FIG. 5, the currents 18 and 19 flow through the two coils 8 and 9 in opposite directions, with the result that these currents flow in the same direction in the coil regions facing each other. The Lorentz forces are now directed in transverse direction in relation to the longitudinal axis and towards the same side of the suspension arm 1, with the force F8 being directed downwards and towards the center on the side of the south pole and the force F9 being directed upwards and outwards on the side of the north pole. Thereby, the resulting total force Fₜₒₜ is directed outwards in transverse direction in relation to the longitudinal axis LA in the plane of the suspension arm 1, initiating a swivel motion of the lever arm 1.1 about the pivot bearing 4 in parallel to the support 2, thereby swiveling the lever arm 1.2 in the direction of the arrow t (FIG. 1). The coil currents I₈ and I₉ must be selected such that the suspension arm actuator which is predefined in its dimensions and its coil and magnet arrangement is moved in a swivel motion about the pivot bearing 4 in parallel and perpendicularly to the support 2, in order to move the optical head (F) to a target position so that it scans a point on an optical disk that is arranged in a plane extending in parallel to the support 2. Said selection defines the Lorentz forces F8 and F9.

### LIST OF REFERENCE SYMBOLS

1 Suspension arm
1.1 Lever arm
1.2 Lever arm
2 Support
3 Magnetic drive
4 Pivot bearing
5 Pivot pin
6 Bearing disk
7 Journal bearing
8 Coil
9 Coil
10 Magnet arrangement
11 Magnet
11.1 Pole shoe
11.1.1 Pole face
11.1.2 Pole face
11.2 Pole shoe
11.2.1 Pole face
11.2.2 Pole face
LA Longitudinal axis
CG Center of gravity
JA Axis
Iₘ Magnetic field
IIₘ Magnetic field
F Focal lens
F8 Lorentz force
F9 Lorentz force
Fₜₒₜ Total force
I₈ Coil current
I₉ Coil current
α Angle

1. A suspension arm actuator for a plurality of directions of motion, comprising a suspension arm which is supported against a support and is mounted to said support such that it can be pivoted, said suspension arm supporting a component that has to be actuated or being operably connected to such a component and being provided with a magnetic drive, wherein the magnetic drive generates an inhomogeneous magnetic field which allows a swivel motion of the component about an axis extending perpendicularly to the suspension arm as well as a motion of the component rectangular to said swivel motion.

2. The suspension arm actuator according to claim 1, wherein the magnetic drive is formed by two coils and a magnet, said coils being attached to the suspension arm on either side of the longitudinal axis of said suspension arm, with their coil axis extending perpendicularly to the suspension arm, wherein pole shoes are allocated to the coils spaced apart from the coil axes, said pole shoes generating the inhomogeneous magnetic field, and wherein the suspension arm, together with the coils, is arranged such that it is free to move in the magnetic field.

3. The suspension arm actuator according to claim 2, wherein that the pole shoes that are arranged spaced apart from the coil axes are provided with pole faces such that a partial magnetic field is generated for each coil, said partial magnetic field comprising a force component in the plane of the suspension arm and/or a force component perpendicularly thereto, and that the two partial magnetic fields are different in their orientation.

4. The suspension arm actuator according to claim 2 wherein a pole shoe allocated to the two coils is arranged on the side of the coils, said pole shoe comprising two pole faces that are formed at an angle to each other and each being allocated to one of the two coils, and that a pole shoe having a pole face is allocated to each coil on the side of the suspension arm, said pole face corresponding with the pole face that is allocated to this coil on the other side thereof.

5. The suspension arm actuator according to claim 4, wherein the pole faces which are each forming a partial magnetic field have an acute angle to each other in order to form an inhomogeneous partial magnetic field.

6. The suspension arm actuator according to claim 2, wherein a first pole shoe comprising two pole faces that are formed at an angle to each other and are each allocated to one of the two coils is arranged above one side, in particular the side facing the two coils, and that a second pole shoe having two separate pole faces and corresponding with the pole faces of the first pole shoe is arranged on the other side, in particular the side arranged opposite to the coils.

7. The suspension arm actuator according to claim 6, wherein that the pole faces of the first pole shoe comprise the form of an equal-sided triangle in a cross-sectional view and that the two pole faces of the second pole shoe are each allocated to one of the two coils and are each wedge-shaped in a cross-sectional view.

8. The suspension arm actuator according to claim 2, wherein the suspension arm is designed as a two-arm lever, that the support of the suspension arm is positioned in the center of gravity thereof, with the support being, in particular, formed by a cardan joint, that the component is arranged at one end of the lever arm, and that the magnetic drive is arranged on the lever arm that is facing away from the component.

9. The suspension arm actuator according to claim 8, wherein the suspension arm is rigid and torsionally stiff.

10. The suspension arm actuator according to claim 8, wherein said suspension arm actuator and an optical scanning device formed therewith can be used in a device for reading of and/or writing to optical storage media.
